(19) United States
(12) Patent Application Publication
(10) Pub. No.: US 2026/0236987 A1
(43) Pub. Date: Aug. 13, 2026

(54) ALGORITHM TO IDENTIFY UNRESOLVED REPORTING ISSUES

(71) Applicant: Truist Bank, Charlotte, NC (US)

(72) Inventors: Robert Allen Shealey, JR., Lewisville, NC (US); Prakash Ratinasubramanian, West Windsor, NJ (US); Krishna Vijaywargiy, Atlanta, GA (US)

(73) Assignee: Truist Bank, Charlotte, NC (US)

(21) Appl. No.: 19/050,218

(22) Filed: Feb. 11, 2025

(51) Int. Cl. G06Q 40/04; G06Q 30/018

(52) U.S. Cl. CPC G06Q 40/04; G06Q 30/018

(57) ABSTRACT

In one aspect, a method, includes transmitting, by a processor, a plurality of messages to a reporting hub, each message associated with a respective event of a plurality of events, determining, by the processor for each message, whether an acknowledgement of the respective message is received or not received from a global repository, generating, by the processor, a report includes a first subset of the plurality of events, the first subset includes events for which the acknowledgment of the corresponding message is not received, generating, by the processor based on a predetermined reporting period, an unresolved event notification for a first event of the first subset of the plurality of events, and transmitting, by the processor to a reporting system, the unresolved event notification within the predetermined reporting period.

### BACKGROUND

Trade reporting systems are necessities of derivative-based financial markets, responsible for the accurate and timely publicly dissemination of trade-related information. These systems provide a framework for capturing and transmitting transactions within various asset classes, including interest rates (IR), commodities (CO), foreign exchange (FX), credit (CR), and equity (EQ).

One of the primary challenges of trade reporting systems is ensuring the entire accurate transaction lifecycle and timeliness requirements are fulfilled with regards to trade reporting. Financial markets operate at high speed, and even minor delays in trade reporting can lead to inefficiencies, increase market risks, and affect decision-making processes. As such, trade reporting systems must be robust and capable of handling large volumes of data in real-time.

Additionally, the detection of trades that were not properly reported poses another significant challenge. Trades that have not been successfully reported may lead to violation of regulatory rules and could incur substantial enforcement actions and/or penalties from various financial regulators. However, conventional systems are not able to promptly identify and communicate any such inconsistencies to relevant parties.

### BRIEF SUMMARY

In various embodiments, a method involves a processor transmitting multiple messages to a reporting hub, with each message corresponding to a specific event out of a series of events. The processor determines for each message whether an acknowledgment has been received from a global repository. If an acknowledgment is not received, the processor generates a report containing a subset of events lacking acknowledgment. Based on a predetermined reporting period, the processor also generates an unresolved event notification for a specific event within this subset and transmits it to a reporting system during the reporting period.

In some embodiments, a non-transitory computer-readable storage medium contains instructions that, when executed by a processor, perform similar steps. These steps include transmitting messages, determining acknowledgment receipt, generating a report for events with missing acknowledgments, producing an unresolved event notification based on a reporting period, and transmitting this notification to a reporting system within the reporting period.

In some embodiments, an apparatus consists of a processor and a memory. The memory holds instructions that, when executed by the processor, enable the processor to perform the aforementioned actions, including message transmission, acknowledgment determination, report and notification generation, and transmission of unresolved event notifications within the designated reporting period.

The features, functions, and advantages that have been described herein may be achieved independently in various embodiments of the present disclosure including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 2C illustrates an aspect of the subject matter in accordance with one embodiment.

FIG. 2D illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates a logic flow 500 in accordance with one embodiment.

FIG. 6 illustrates a computing system 600 in accordance with one embodiment.

### DETAILED DESCRIPTION

Embodiments disclosed herein provide a recursive algorithm to identify unresolved regulatory reporting issues. Currently, laws or other regulatory requirements may require that any trade of a security, commodity, etc., be reported via one or more global trading repositories (GTRs). Although swap dealer trades are discussed as a reference example herein, any type of traded asset may be reported. Generally, embodiments disclosed herein provide a recursive algorithm to process trade messages, identify errors, and ensure compliance with regulatory requirements.

In some embodiments, the algorithm includes submitting trade messages to a reporting hub, which is a central repository for consolidating trade messages and forwarding the trade messages to at least one GTR. In some embodiments, the reporting hub may return an error or failure message (e.g., when a trade message is not properly formatted, contain valid required and/or conditional fields, etc.).

When the reporting hub transmits valid trade messages to the GTR, the GTR may ingest the messages and send any number and types of responses to a server or other device executing the algorithm. In some embodiments, the GTR does not send any response. In some embodiments, the GTR sends an acknowledgment (ACK) message, a non-acknowledgment (NACK) message, or a failure message to the server or other device executing the algorithm. Trades that receive a NACK, a failure (from the GTR and/or the reporting hub), or no response are flagged for further analysis. For example, trades that receive a NACK, failure, or no response may be added to a report, while trades that receive an ACK are not added (or otherwise removed) from the report. The report may generally include all trades (and/or trade messages) that have unresolved issues. The algorithm then recursively checks all messages to identify unresolved issues. For example, for trades that have failed or received a NACK, embodiments may determine whether subsequent acknowledgements have been received. This process ensures that unresolved issues are continuously monitored and updated.

At periodic time intervals (e.g., hourly, daily, weekly, etc.), the algorithm reviews the latest submission reports from the GTR. Doing so allows the status of trades to be updated, including removing those that have been successfully acknowledged from the report. The algorithm identifies trades that have failed or received a NACK and ensures they are addressed within a specified timeframe, such as seven business days. If a trade remains unresolved after this period, a notification is generated for compliance to report the issue to the relevant regulatory body.

For example, a server may generate a first trade message and a second trade message for a first trade and a second trade of a plurality of trades, respectively. The server may transmit the first and second trade messages to a reporting hub, who in turn forwards the trade messages (or indications thereof) to the GTR. The GTR may return, to the server, an acknowledgment for the first trade message. The server may then determine, based on the acknowledgment, that the first trade message (and by association, the first trade), have been properly reported, thereby complying with regulatory requirements. However, for the second trade message, a NACK, a failure, and/or no response may be received by the server. The server may then add the second trade message (and/or the second trade) to the report of trades having unresolved issues. In some embodiments, an indication of the addition of the unresolved second trade message may be transmitted to one or more users via a network. In some embodiments, the report is transmitted to one or more users at predetermined time intervals (e.g., hourly, daily, etc.).

Because trades may have a predetermined reporting period (e.g., 7 business days), any trade must be successfully reported to the GTR within this predetermined reporting period to comply with applicable regulations. Advantageously, the server may continue to monitor messages received from the GTR to determine whether an ACK is received for the second trade message. If an ACK for the second trade message is not received within the predetermined reporting period, the server may generate and transmit an unresolved trade notification to one or more regulatory bodies, thereby complying with the predetermined reporting grace or analysis period.

As another example, embodiments disclosed herein may identify changes to the status of a trade. For example, after receiving the ACK for the first trade, a NACK or failure for the first trade may be received. As such, embodiments disclosed herein may add the first trade to the report (and/or generate a notification reflecting the unresolved issued for the first trade) and monitor for another ACK for the first trade.

Part 43 of the swap dealer reporting requirements, as established by the Commodity Futures Trading Commission (CFTC), focuses on real-time public reporting of swap transaction and pricing data. Part 43 enhances transparency and price discovery in the swaps market. This part mandates that all publicly reportable swap transactions, which include swaps that change market risk positions or affect pricing, must be reported and publicly disseminated in real-time. The rules ensure the anonymity of market participants and allow for time delays in the public dissemination of certain swap transaction data.

Part 45 of the swap dealer reporting requirements deals with the recordkeeping and reporting of swap data, ensuring comprehensive data on swap transactions is maintained and reported to swap data repositories. It requires the reporting of swap creation data, which includes all primary economic terms and confirmation data, as soon as technologically practicable. Additionally, it involves the reporting of continuation data, covering lifecycle events and valuation data throughout the life of the swap. Part 45 also mandates the use of unique transaction identifiers (UTIs), legal entity identifiers (LEIs), and unique product identifiers (UPIs) to ensure accurate tracking and reporting of swap data.

Part 46 of the swap dealer reporting requirements mandates the recordkeeping and reporting of pre-enactment and transition swaps. Generally, dealers and major swap participants are required to report data for these swaps to a repository, including the minimum primary economic terms, confirmation data, and any other necessary data elements. Part 46 requires that entities maintain accurate and accessible records of all reported data, including any modifications or corrections. The data must be reported electronically using the standards provided by the SDR to ensure consistency and accuracy in the reporting process.

Advantageously, embodiments disclosed herein automate the process of identifying and reporting unresolved trade issues, reducing the need for manual intervention and increasing the accuracy of trade reporting systems. The accuracy of such systems is improved, as embodiments disclosed herein ensure that all unresolved trade issues are identified and addressed in compliance with any rules and/or requirements. Furthermore, embodiments disclosed herein ensure that only unresolved issues are reported, thereby reducing unnecessary notifications and improving the performance of computing systems (e.g., by not processing, transmitting, receiving, and/or storing unnecessary notifications). Furthermore, embodiments disclosed herein maintain regulatory compliance by systematically identifying and reporting unresolved issues. Doing so is valuable for parties who need to manage large volumes of trade data and ensure timely and accurate reporting to regulatory bodies. Therefore, embodiments disclosed herein reflect an improvement in the functioning of a computer or an improvement to other technology or a technical field by improving the accuracy and timing of computing systems that report large volumes of trades.

Aspects of the present disclosure and certain features, advantages, and details thereof are explained more fully below with reference to the non-limiting examples illustrated in the accompanying drawings. Descriptions of well-known processing techniques, systems, components, etc. are omitted so as to not unnecessarily obscure the disclosure in detail. It should be understood that the detailed description and the specific examples, while indicating aspects of the disclosure, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Like numbers refer to like elements throughout.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the disclosure. Therefore, it is to be understood that, within the scope of the included claims, the disclosure may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present disclosure can include fixed function hardware, while other embodiments can utilize a software-based implementation of the functionality described. Certain embodiments combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

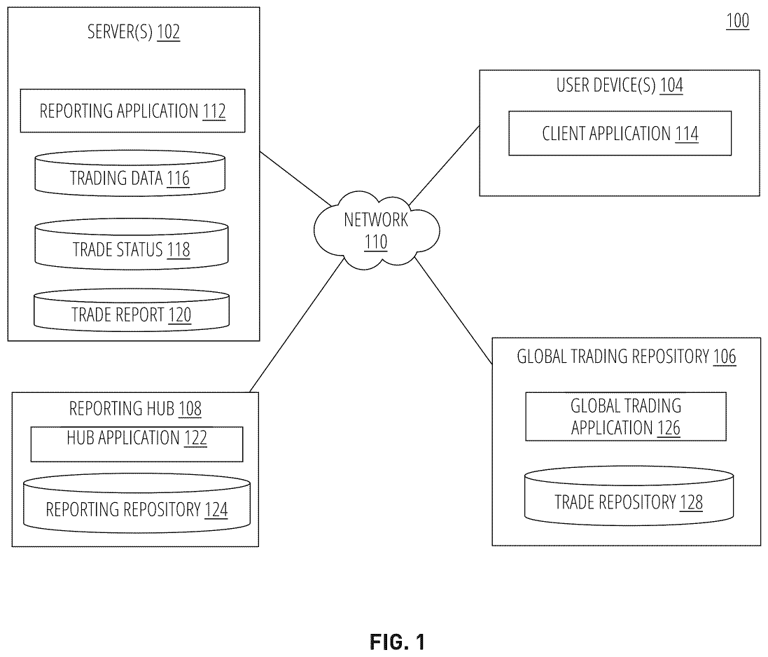

FIG. 1 illustrates a system 100 according to one embodiment. As shown, the system 100 includes one or more servers 102, one or more user devices 104, one or more global trading repositories 106, and one or more reporting hubs 108 communicably coupled via one or more networks 110. The servers 102, user devices 104, global trading repositories 106, and reporting hubs 108, are representative of any type of physical and/or virtualized computing system. The servers 102, user devices 104, global trading repositories 106, and reporting hubs 108 each include at least one processor for executing instructions and at least one local or cloud-based memory for storing instructions, each not pictured for the sake of clarity.

As shown, the server 102 includes a reporting application 112, a data store of trading data 116, a data store of trade status 118, and a data store of trade reports 120. The reporting application 112 is generally configured to access the trading data 116, which describes one or more trades. The trades may be of any security, asset, tenor (distance between effective and termination dates) etc. The trading data 116 may be generated based on the execution of a trade, e.g., the sale of an option, generation of a swap between counterparties, termination of an existing position, execution of any future or historical trade etc. The trading data 116 may be updated automatically and/or according to predetermined time intervals (e.g., hourly, daily, etc.). The trading data 116 may be received from any suitable source, such as the client application 114 which may be used to execute or otherwise report the trades as trading data 116. Some jurisdictions may require that a given trade be reported to at least one of the global trading repositories 106 within a predetermined reporting period (e.g., 1 hour, 24 hours, 7 days, 14 days, etc.).

In some embodiments, the reporting application 112 receives input that includes submissions files reflecting receipts of ACK messages from the global trading repository 106, NACK messages received from the global trading repository 106, and trades that failed or otherwise did not process. In some embodiments, the input to the reporting application 112 includes one or more of the trade reports 120. In some embodiments, the input to the reporting application 112 may be time-limited, e.g., to data for the current month and two months prior. Embodiments are not limited in these contexts.

To report the trades associated with trading data 116, the reporting application 112 may generate a trade message for each trade. The trade message may include metadata describing a given trade in the trading data 116, such as a unique identifier (ID), asset being bought or sold, the parties, price, execution timestamp, etc. In some embodiments, the reporting application 112 generates a file including the plurality of trade messages and transmits the file to the reporting hub 108. The reporting application 112 may then transmit the trade messages to the reporting hub 108, which is a centralized platform to receive trade messages from reporting parties (e.g., a financial institution associated with the server 102, other financial institutions, etc.), store the trade messages in a reporting repository 124 (e.g., a message queue), and send indications of the trade messages to one or more of the global trading repositories 106.

When a message is received by the global trading repository 106, the global trading application 126 may process the message. If the global trading application 126 successfully processes the message (and by association, the corresponding trade), the global trading application 126 may return an acknowledgment (ACK) message to the reporting application 112. The global trading application 126 may store an indication of the processed trade in the trade repository 128.

However, in some embodiments, the global trading application 126 may not successfully process the message (and by association, the corresponding trade). For example, data fields in a message may be omitted, incorrect, etc., such that the global trading application 126 cannot validate or otherwise process the message. In such embodiments, the global trading application 126 may transmit a non-acknowledgment (NACK) message to the reporting application 112. In some embodiments, however, a failure message may be transmitted to the reporting application 112. Any responses received by the reporting application 112 may be stored in the trade status 118.

Similarly, in some embodiments, the reporting hub 108 may return a failure message to the reporting application 112 based on the initial transmission of the trade message. Furthermore, in some embodiments, the reporting application 112 may not receive a response from the reporting hub 108 or the global trading repository 106. Therefore, the reporting application 112 may consider any trades that receive a NACK, a failure, or no response as having unresolved issues (e.g., were not properly reported). Embodiments are not limited in these contexts, as a failure may occur due to any internal/external communication issue.

The reporting application 112 may generally maintain one or more trade reports 120. A trade report 120 may generally include a list of a plurality of trades that have not been successfully reported to the global trading repository 106. The reporting application 112 may generally include, in a trade report 120, each outstanding trade that has not been processed. For example, if a trade receives an ACK from the global trading repository 106, the reporting application 112 does not include the trade in the trade report 120. If, however, a NACK, failure (from the reporting hub 108 and/or the global trading repository 106), or no response is received for a message, the reporting application 112 may add the message (and corresponding trade, by association) to the trade report 120.

The reporting application 112 may then transmit an indication of the trades in the trade report 120 to a plurality of recipients. Furthermore, the reporting application 112 may monitor the trades on the trade report 120 until or after the predetermined reporting period elapses. Generally, as the reporting hub 108 and/or global trading repository 106 return messages to the reporting application 112, these messages may be stored in the trade status 118. For example, the reporting hub 108 and/or global trading repository 106 may return error (or failure) messages that may be stored in the trade status 118 for the corresponding message and/or trade. Similarly, the global trading repository 106 may return ACKs and/or NACKs to the reporting application 112, which in turn stores indications of these messages in the trade status 118 for the corresponding message and/or trade.

Thereafter, at predetermined time intervals (e.g., hourly, daily, weekly, etc.), the reporting application 112 may automatically/systematically process required correction submissions to trades on the trade report 120 based on any newly received messages stored in the trade status 118 or trade report 120. For example, if a first trade is on the trade report 120, the reporting application 112 may reference the trade status 118 (e.g., based on the unique ID of the first trade) and determine whether any messages associated with the first trade are stored therein. For example, if the trade status 118 indicates the first trade received an ACK message from the global trading repository 106, the reporting application 112 may remove (either via batch or real-time) the first trade from the trade report 120, as the global trading repository 106 successfully processed the first sequence of a trade. The processing of a trade by the global trading repository 106 may include executing the trade, modifying, amending, exercising, novating, porting, correcting, terminating, erroring or reviving a trade, and/or recording an indication of the trade in the trade repository 128.

For any trades in the trade status 118 that have not received an ACK within the predetermined reporting period, the reporting application 112 may automatically generate and submit a compliance report. The compliance report may indicate the trade and any number of attributes thereof. The reporting application 112 may then transmit the compliance report to the appropriate regulatory authorities and/or the global trading repositories 106.

For example, if a second trade receives a NACK after initial submission, the reporting application 112 may monitor the messages received from the reporting hub 108 and/or global trading repositories 106 to determine whether an ACK is received within the predetermined reporting period. If, prior to the expiration of the predetermined reporting period (e.g., on the day of, an hour before the expiration of the predetermined reporting period, etc.), the ACK is not received, the reporting application 112 may generate the compliance report and send the compliance report to the appropriate recipients. Doing so ensures compliance with regulations.

Furthermore, the status of a given trade may change over time. For example, an ACK may be received from the global trading repository 106 for a trade message, which causes the reporting application 112 to refrain from adding the trade message to the trade report 120. However, a subsequent NACK or failure may be received from the global trading repository 106 subsequent to the ACK. As such, the reporting application 112 may add the trade message (and associated trade) to the trade report 120, which allows the reporting application 112 to continue to monitor for an acknowledgment, and generate a compliance report if the acknowledgment is not received within the predetermined reporting period.

More generally, the recursive algorithm of the reporting application 112 may be executed over predetermined time intervals (e.g., hourly, daily, etc.) to identify unresolved trades. For example, the reporting application 112 may identify trade messages that are not validated by the reporting hub 108 and add these messages to the trade report 120. Further still, the reporting application 112 may identify trade messages that do not reach the reporting hub 108 for other issues (e.g., connectivity issues, etc.) and add these messages to the trade report 120. As another example, the reporting application 112 may identify trade messages that are received by the reporting hub 108 but not transmitted to the global trading repository 106 and add these messages to the trade report 120. As another example, the reporting application 112 may identify trade messages that receive a NACK from the global trading repository 106 and add these messages to the trade report 120. As another example, the reporting application 112 may identify trade messages that receive an ACK from the global trading repository 106 then subsequently receive a NACK from the global trading repository 106 and add these messages to the trade report 120. Continuing with this example, the reporting application 112 may identify trade messages that receive an ACK, followed by a NACK, followed by another ACK, followed by another NACK (and so on) and add these messages to the trade report 120.

In some embodiments, a submission key (e.g., the contents of a message submitted to the global trading repository 106 and/or a message received from the global trading repository 106) may include the following parameters: a unique transaction identifier, an action type, an event type, an amendment indicator, a message type, and a jurisdiction. For example, the submission key may include the following values, delimited by colons (where two or more consecutive colons indicates a value not present for one or more fields): HMFLA8WOKSB597422Q14TRSI000000000000000000003129838:TERM:ETRM::RT:SEC.

In some embodiments, the reporting application 112 includes systematic features to identify issues with a given trade. For example, the reporting application 112 may identify false positives included in the trade report 120. For example, by identifying trades that have received an ACK from the global trading repository 106, but subsequently receive a NACK due to resubmitting the trade to the global trading repository 106, the NACK may be removed from the trade report 120 based on detecting the false positive(s) where resubmissions would never fully rectify the root-case issue. As another example, trades that received ACKs from the global trading repository 106 that are resubmitted and do not receive a response may be identified as a false positive and removed from the trade report 120.

In some embodiments, the reporting application 112 may generate one or more graphical user interfaces. For example, the reporting application 112 may generate a user-friendly daily snapshot of trades on one or more trade reports 120. In some embodiments, the snapshot may reflect trade volumes by asset class, error codes, etc. In some embodiments, the snapshot may group trades by asset class and/or age (e.g., 1 day old, 2 days old, etc.).

In some embodiments, when the reporting application 112 receives a new message (e.g., an ACK, NACK, failure, etc.), the reporting application 112 may determine the number of trades impacted by the message, the root cause of a NACK and/or failure (e.g., by validating the data included in trade messages, identifying erroneous data, missing values, etc.), percentages of trades impacted, how the trades were identified. In some embodiments, the reporting application 112 may generate a GUI that lists all unresolved trade notifications generated and transmitted. As stated, the reporting application 112 may generate the unresolved trade notifications. In some embodiments, the reporting application 112 generates unresolved trade notifications based on existing data (e.g., in the trading data 116, trade status 118, messages, etc.), generating values to include in the unresolved trade notifications, etc.

In some embodiments, regulations may change over time. Advantageously, the reporting application 112 is configured to adapt to changing regulations. For example, a new regulation may take effect on a Monday that mandates additional data fields to be included in trade messages for compliance. On the Friday before the Monday the regulation takes effect, the system 100 functions correctly, and all trade messages are being acknowledged (ACKed) by the global trading repository 106. On Monday, the regulation is implemented, requiring additional data fields in the trade messages. However, the system 100 is not updated to include these new or removed data fields.

On Monday, the reporting application 112 continues to submit trade messages without the newly required data fields. The global trading repository 106, now operating under the new regulation, evaluates the incoming trade messages and, since they lack the required data fields, sends NACK messages back to the reporting application 112. The recursive algorithm executed by the reporting application 112 identifies that the trade messages, which were previously acknowledged, that are now receiving NACKs due to the missing data fields required by the new regulation. Consequently, the reporting application 112 flags these trade messages as unresolved issues that need to be addressed, e.g., by storing indications of these messages in the trade reports 120.

In some embodiments, one or more users are notified of the unresolved issues, prompting an update to the reporting application 112 to include the new data fields required by the regulation. In some embodiments, the reporting application 112 self corrects, e.g., by identifying indications of the error in the NACK (e.g., which data fields are not present, which data fields had erroneous values, which data fields had erroneous data types, etc.) and modifying the messages to include the required data fields. For example, if the NACK indicates an ID is missing from a message, the reporting application 112 may determine the value for the ID based on the entry for the trade in the trading data 116. The corrected trade messages are then resubmitted to the global trading repository 106, which acknowledges the corrected trade messages, thereby resolving the issues. This example illustrates how the introduction of a new regulation can cause previously compliant trade messages to receive NACKs if the reporting system is not updated accordingly. The recursive algorithm of the reporting application 112 identifies and addresses these issues to ensure ongoing compliance with regulatory requirements.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 110 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 104 may include automatic teller machines (ATMs) utilized by the system 100 in serving users. In another example, the servers 102 represent payment clearinghouse or payment rail systems for processing payment transactions, and in another example, the servers 102 such as merchant systems or banking systems configured to interact with the user devices 104 during transactions and also configured to interact with the enterprise system 100 in back-end transactions clearing processes.

The user devices 104 may also be configured to obtain and process various forms of authentication via an authentication system to obtain authentication information of a user. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

System 100 as illustrated diagrammatically represents at least one example of a possible implementation, where alternatives, additions, and modifications are possible for performing some or all of the described methods, operations, and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized, or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 104) to serve users in their interactions to communicate and take action. In such embodiments, the user devices 104 can be, as non-limiting examples, computing devices, kiosks, terminals, smart devices such as phones, and devices and tools at customer service counters and windows at POS locations.

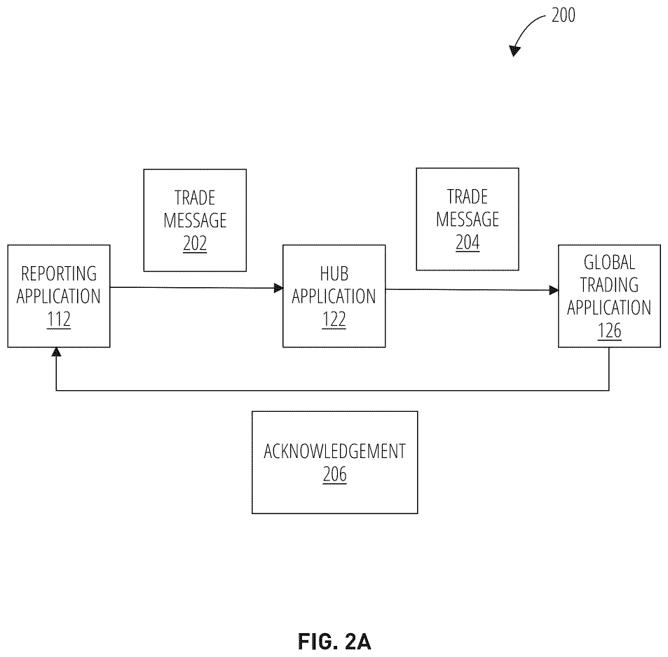

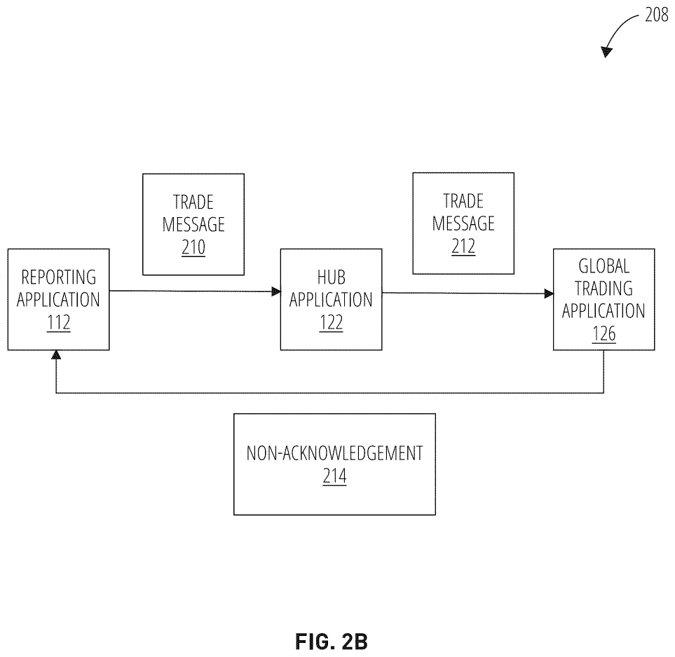

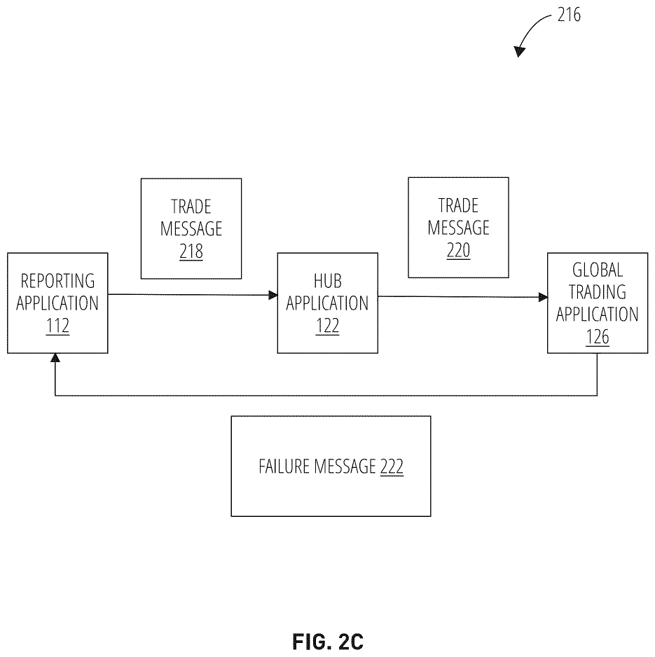

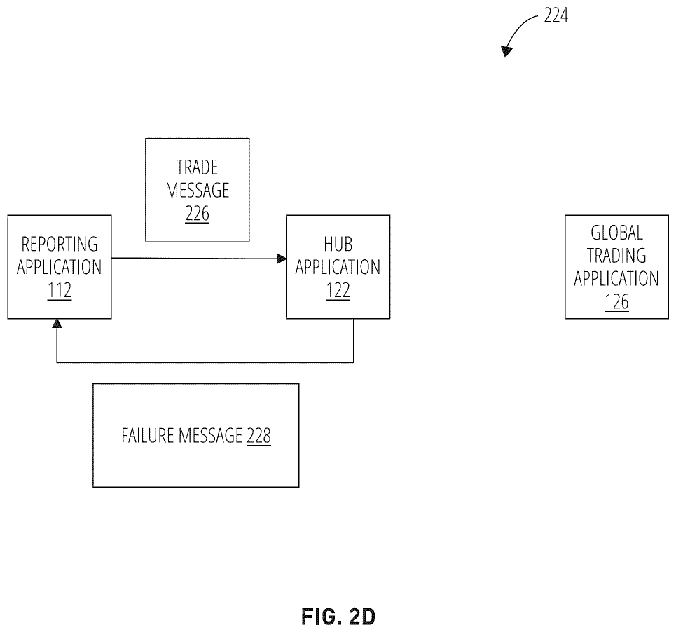

FIG. 2A is a schematic 200 illustrating an example processing flow, according to one embodiment. As shown, the reporting application 112 may generate a trade message 202, which includes indications of a trade to be reported to the global trading repository 106. In some embodiments, the trade message 202 includes indications of a plurality of trades. The reporting application 112 may transmit the trade message 202 to the hub application 122. In some embodiments, the hub application 122 stores the trade message 202 (or indications thereof) in the reporting repository 124. The hub application 122 may then generate a trade message 204 based on the trade message 202. In other embodiments, the hub application 122 sends the trade message 204 to the global trading repository 106 without storing the trade message 202 in the reporting repository 124.

The trade message 204 includes indications of each trade (e.g., one or more fields and columns) included in the trade message 202. In some embodiments, the trade message 204 is the same as trade message 202. In some embodiments, the trade message 204 is different than the trade message 202. The global trading application 126 may then successfully process the trade message 204 and transmit one or more acknowledgements 206 to the reporting application 112. For example, the acknowledgement 206 may reflect multiple trades that were successfully processed by the global trading application 126. As another example, the global trading application 126 may generate a separate acknowledgement 206 for each successfully processed trade in the trade message 202.

FIG. 2A therefore depicts an embodiment where a trade is successfully reported to the global trading repository 106. Because the acknowledgement 206 is received, the reporting application 112 does not add any the trade message 202 (and any associated trades) to the trade report 120.

Although referred to as trade messages, embodiments are equally applicable to other types of messages. For example, the trade messages may include part 43 messages, part 45 messages, part 46 messages, valuation messages, collateral messages, or any other type of continuation data requirement.

FIG. 2B is a schematic 208 illustrating an example processing flow, according to one embodiment. As shown, the reporting application 112 may generate a trade message 210, which includes an indication of a trade to be reported to the global trading repository 106. The reporting application 112 may transmit the trade message 210 to the hub application 122. The hub application 122 may then generate a trade message 212 based on the trade message 210.

The trade message 212 includes indications of each trade included in the trade message 202. As shown, the global trading application 126 may then process the trade message 212 and transmit a non-acknowledgement 214 to the reporting application 112. For example, the non-acknowledgement 214 may that the trades in the trade message 220 were not successfully processed by the global trading application 126. Generally, any number or types of reasons may lead to the unsuccessful processing of the trade message 212, such as invalid data fields (missing required fields based on various regulatory changes or logic-based conditions) in the trade message 212, empty data fields in the trade message 212, etc. Embodiments are not limited in these contexts.

Because the non-acknowledgement 214 is received, the reporting application 112 may add an indication of the trade message 210 (and any associated trades) to the trade report 120.

FIG. 2C is a schematic 216 illustrating an example processing flow of a failure, according to one embodiment. As shown, the reporting application 112 may generate a trade message 218, which includes an indication of a trade to be reported to the global trading repository 106. The reporting application 112 may transmit the trade message 218 to the hub application 122. The hub application 122 will not fully generate a trade message 220 based on the trade message 218.

The trade message 220 includes indications of transformation of various values or dates of each trade included in the trade message 218. As shown, the global trading application 126 may then process the trade message 220 and transmit a failure message 222 to the reporting application 112. For example, the failure message 222 may indicate that the trades in the trade message 220 were not successfully processed by the global trading application 126. Generally, any number or types of reasons may lead to the unsuccessful processing of the trade message 220, such as system errors, system downtime, connectivity issues, etc. Embodiments are not limited in these contexts.

Because the failure message 222 is received, the reporting application 112 may add an indication of the trade message 218 (and any associated trades) to the trade report 120 with limited information such as only the unique trade ID.

FIG. 2D is a schematic 224 illustrating an example processing flow, according to one embodiment. As shown, the reporting application 112 may generate a trade message 226, which includes an indication of a trade to be reported to the global trading repository 106. The reporting application 112 may transmit the trade message 226 to the hub application 122. However, as shown, the hub application 122 returns a failure message 228 to the reporting application 112.

Generally, any number or types of reasons may lead to the unsuccessful processing of the trade message 226, such as system errors, connectivity issues, etc. Embodiments are not limited in these contexts. However, the failure associated with failure message 228 means the hub application 122 does not send indications of the trade message 226 to the global trading repository 106. As such, one or more trades associated with trade message 226 are not successfully processed by the global trading repository 106.

Because the failure message 228 is received, the reporting application 112 may add an indication of the trade message 218 (and any associated trades) to the trade report 120.

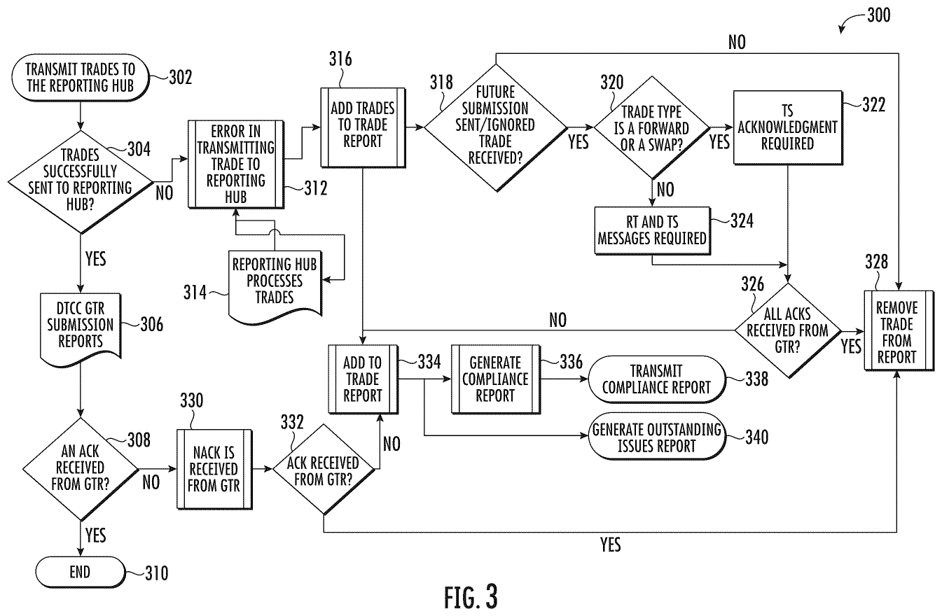

FIG. 3 illustrates an example logic flow 300 for a recursive algorithm to identify unresolved reporting issues, according to one embodiment. Although the example logic flow 300 depicts a particular sequence of operations, the sequence may be altered without departing from the scope of the present disclosure. For example, some of the operations depicted may be performed in parallel or in a different sequence that does not materially affect the function of the logic flow 300. In other examples, different components of an example device or system that implements the logic flow 300 may perform functions at substantially the same time or in a specific sequence.

At block 302, the reporting application 112 may transmit trades to the reporting hub 108. For example, the reporting application 112 may transmit a file, one or more messages, etc., including indications of one or more trades to be reported to the global trading repository 106. Each trade may be associated with a unique identifier one or more attributes of the trade. The unique identifier may be any unique identifier, such as a string of digits or alphanumeric characters.

At decision block 304, the reporting application 112 determines whether the trades transmitted at block 302 were successfully sent to the reporting hub 108. If yes, the logic flow 300 proceeds to decision block 308, where the reporting application 112 determines whether an ACK message is received from the global trading repository 106 for each trade transmitted at block 302. If yes, the trades have been acknowledged, and the logic flow 300 ends at block 310.

Returning to decision block 304, if the trades are not successfully transmitted to the reporting hub 108, the logic flow 300 may proceed to block 312, and/or block 314. For example, at block 312, the trades submitted at block 302 may not be received by the reporting hub 108. As another example, at block 312 an error or other failure may occur such that the reporting hub 108 does not receive or otherwise successfully process the trades transmitted at block 302. The reporting hub 108 may continue to process each trade received from the reporting application 112 at block 314, e.g., to transmit indications of the trade to the global trading repository 106 and/or return failures to the reporting application 112.

At block 316, the reporting application 112 adds indications of each trade transmitted at block 302 to the trade report 120, as the reporting hub 108 did not receive these trades and/or encountered an error in processing the trades. The logic flow 300 may then continue to block 334.

At decision block 318, the reporting application 112 determines whether a future submission is sent for the trades, or if a previously submitted trade was ignored due to reporting party eligibility logic where the submitting party is not the “Reporting Party” per tie-breaker logic defined by ISDA. If no, the logic flow 300 proceeds to block 328. If decision block 318 results in a no, the logic flow 300 proceeds to block 328. If decision block 318 results in a yes, the logic flow 300 proceeds to decision block 320, where the reporting application 112 determines whether a type of the trade is a forward (also referred to as an “FX forward”) or a swap. If the trade is not a forward or a swap, the logic flow 300 proceeds to block 324. At block 324, the reporting application 112 determines that real time (part 43-RT) and trade state (part 45-Trade State) messages are required for the trade. Therefore, the reporting application 112 may store an indication that real time and trade state messages must be received from the global trading repository 106 as preconditions for successful processing of the associated trade. For example, if real time and trade state messages are not received from the global trading repository 106 for a trade within the predetermined reporting period, the reporting application 112 may keep the trade on the trade report 120.

Returning to decision block 320, if the trade is a FX forward or a FX swap, the logic flow 300 proceeds to block 322. At block 322, the reporting application 112 determines that a single acknowledgment is required (e.g., a trade state acknowledgment).

From block 324 or block 322, the logic flow 300 may proceed to block 328. At block 328, the reporting application 112 determines whether an acknowledgment is received from the global trading repository 106 for the trade. For example, the reporting application 112 may reference the trade status 118 to determine whether an acknowledgment exists for a trade based on the unique ID for the trade. As stated, some types of trades require multiple acknowledgments. Therefore, for trades that require multiple acknowledgments, the reporting application 112 determines whether all acknowledgments are received at decision block 326.

If the acknowledgment (or acknowledgments) are received, the logic flow 300 proceeds to block 328. At block 328, the trade being analyzed is removed from the trade report 120, because the trade has been acknowledged.

Returning to decision block 308, if an ACK is not received from the global trading repository 106, the logic flow 300 proceeds to block 330. At block 330, the reporting application 112 determines a NACK is received for the trade from the global trading repository 106. At decision block 332, the reporting application 112 determines whether an ACK has been received from the global trading repository 106 subsequent to the NACK determined at block 330. If the ACK is received subsequent to the NACK, the logic flow 300 proceeds to block 328, e.g., where the trade is removed from the trade report 120.

Returning to decision block 332, if an ACK is not received subsequent to the NACK, the trade is added to the trade report 120 at block 334. In some embodiments, based on the addition of a trade to the trade report 120, the reporting application 112 transmits a notification to one or more recipients. For example, at block 340, the reporting application 112 may generate a report including all outstanding issues included in the trade report 120.

At block 336, if the predetermined reporting period has elapsed, the logic flow 300 includes the reporting application 112 generating a compliance report. Generally, at block 336, one or more trades have not received an acknowledgment. As such, these trades have not been reported within the predetermined reporting period. Therefore, the reporting application 112 may generate the compliance report for the trade and transmit the compliance report at block 338, e.g., to the global trading repository 106, a regulatory agency, the government, etc. Embodiments are not limited in these contexts.

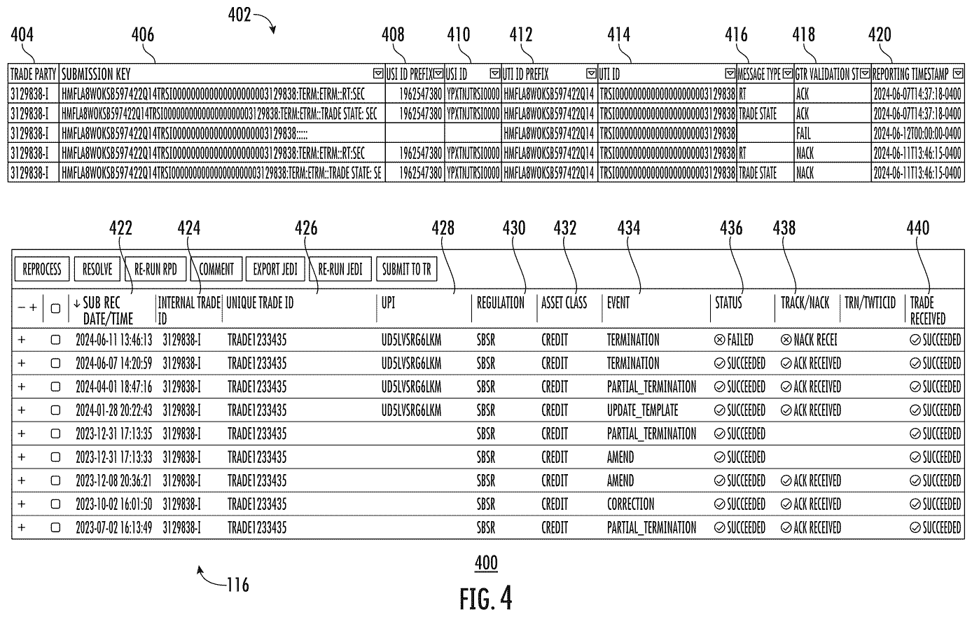

FIG. 4 illustrates a graphical user interface (GUI) 400. In some embodiments, the GUI 400 is generated by the reporting application 112.

As shown, the GUI 400 includes a section for messages 402. The messages 402 may be received from the global trading repository 106 and/or the reporting hub 108. As shown, each message in the messages 402 includes a party column 404 (e.g., a party submitting the trade), a submission key column 406, a unique swap identifier (USI) ID prefix column 408, a USI ID column 410, a unique transaction identifier (UTI) ID prefix column 412, a UTI ID column 414, a message type column 416, a GTR validation state column 418, a timestamp column 420, and a submission timestamp column 422.

The lower portion of the GUI 400 depicts trading data 116, e.g., data reflecting trades submitted to the global trading repository 106. As shown, the trading data 116 includes an internal trade ID column 424, a UTI ID column 426, a unique product identifier (UPI ID) column 428, a regulation column 430, an asset class column 432, an event column 434, a status column 436, a message received type column 438, and a trade received column 440.

The GUI 400 generally depicts an embodiment where a trade receives an ACK message 402, followed by a NACK message 402, followed by another ACK message 402, and followed by another NACK message 402. Because the final NACK was received, the trading data 116 is added the trade to the trade report 120.

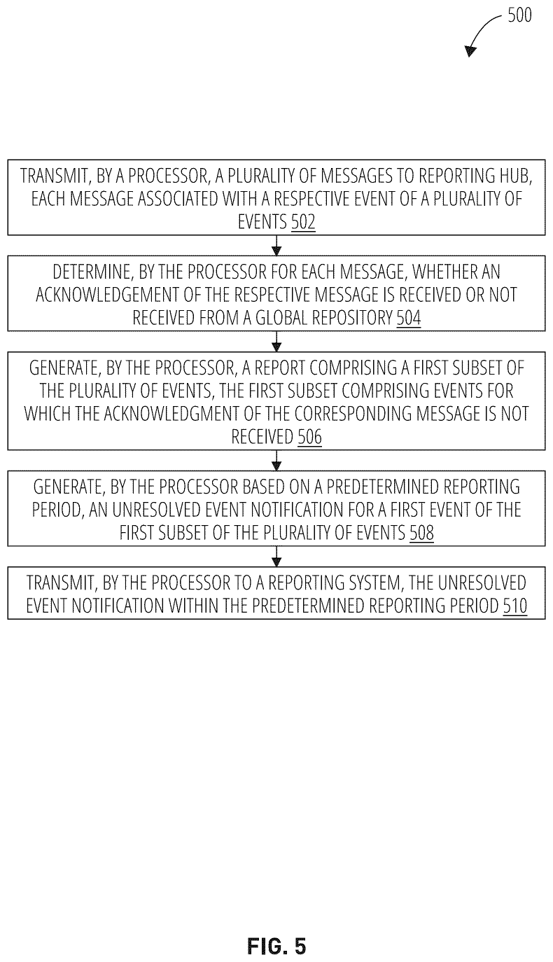

FIG. 5 illustrates an example logic flow 500 for a recursive algorithm to identify unresolved reporting issues, according to one embodiment. Although the example logic flow 500 depicts a particular sequence of operations, the sequence may be altered without departing from the scope of the present disclosure. For example, some of the operations depicted may be performed in parallel or in a different sequence that does not materially affect the function of the logic flow 500. In other examples, different components of an example device or system that implements the logic flow 500 may perform functions at substantially the same time or in a specific sequence.

According to some examples, the logic flow 500 includes transmitting, by a processor, a plurality of messages to a reporting hub, each message associated with a respective event of a plurality of events at block 502. For example, the reporting application 112 illustrated in FIG. 1 may transmit a plurality of trade messages to the reporting hub 108, each trade message associated with a respective trade of a plurality of trades. In some embodiments, the plurality of trade messages may be included in a single message, e.g., in a file including a plurality of messages for a plurality of trades.

According to some examples, the logic flow 500 includes determining, by the processor for each message, whether an acknowledgement of the respective message is received or not received from a global repository at block 504. For example, the reporting application 112 illustrated in FIG. 1 may determine, for each trade message, whether an acknowledgement of the respective trade message is received or not received from a global trading repository 106.

According to some examples, the logic flow 500 includes generating, by the processor, a report comprising a first subset of the plurality of events, the first subset comprising events for which the acknowledgment of the corresponding message is not received at block 506. For example, the reporting application 112 illustrated in FIG. 1 may generate a trade report 120 comprising a first subset of the plurality of trades, the first subset comprising trades for which the acknowledgment of the corresponding trade message is not received. Furthermore, the trade report 120 may include trades for which no response is received and/or an error or other failure message is received.

According to some examples, the logic flow 500 includes generating, by the processor based on a predetermined reporting period, an unresolved event notification for a first event of the first subset of the plurality of events at block 508. For example, the reporting application 112 illustrated in FIG. 1 may generate, based on a predetermined reporting period, an unresolved trade notification for a first trade of the first subset of the plurality of trades. The notification may include indications of a unique ID for the first trade and a plurality of metadata attributes for the first trade.

According to some examples, the logic flow 500 includes transmitting, by the processor to a reporting system, the unresolved event notification within the predetermined reporting period at block 510. For example, the reporting application 112 illustrated in FIG. 1 may transmit, to a reporting system such as global trading repository 106 or another system such as reporting hub 108, the unresolved trade notification within the predetermined reporting period.

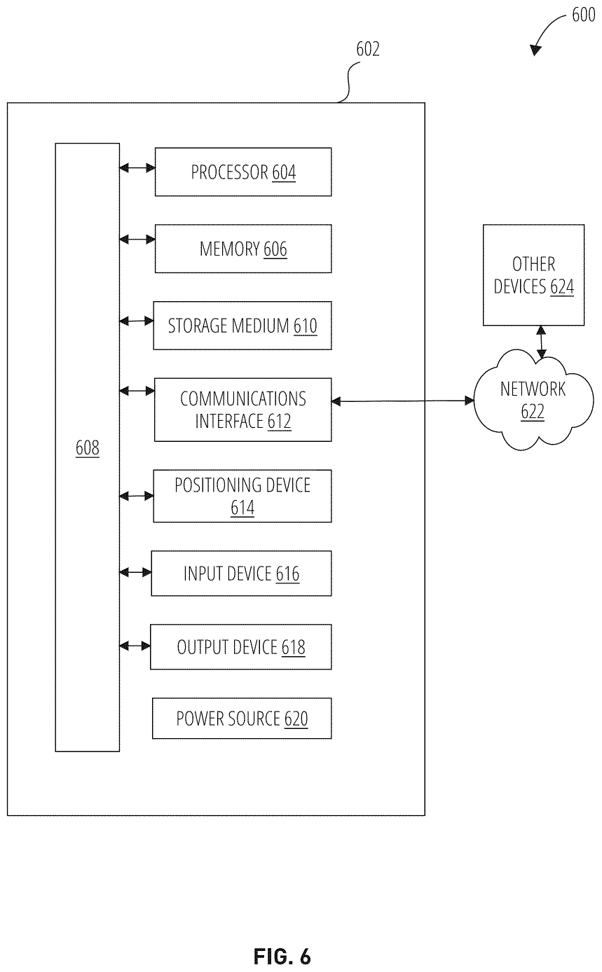

FIG. 6 illustrates an example computing system 600 suitable for implementing various embodiments as described herein. As shown, the computing system 600 comprises a computer 602, which is representative of any type of physical and/or virtualized computing device. Examples of the computer 602 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 602 is representative of some or all of the components of the servers 102, user devices 104, global trading repositories 106, and/or reporting hubs 108. More generally, the computing system 600 is configured to implement all systems, methods, apparatuses, media, and embodiments disclosed herein.

As shown, the computer 602 includes one or more processors 604, one or more memories 606, one or more non-transitory storage media 610, one or more communications interfaces 612, one or more positioning devices 614, one or more input devices 616, and one or more output devices 618 communicably coupled via an interconnect 608. A power source 620, such as a power supply, battery, or any type of power source may provide power to the computer 602.

The processor 604 is representative of any type of processing circuit. For example, the processor 604 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 606 is representative of any computer readable medium to store data, code, or other information. The memory 606 may include volatile memory, such as volatile Random Access Memory (RAM) including a cache area for the temporary storage of data. The memory 606 may also include non-volatile memory, which can be embedded and/or may be removable. The non-volatile memory can additionally or alternatively include an electrically erasable programmable read-only memory (EEPROM), flash memory or the like. The storage medium 610 is representative of any type of computer readable medium to store data, code, or other information. Examples of storage media 610 include solid state drives, hard drives, Redundant Array of Independent Disks (RAID) drives, memory pools, universal serial bus (USB) storage devices, and the like.

The memory 606 and storage medium 610 can store any number and type of computer-executable instructions executed by the processor 604 to implement the functions of the computer 602 described herein. For example, the memory 606 may include such applications as a web browser application and/or a mobile P2P payment system client application. These applications also typically provide a graphical user interface (GUI) on a display that allows the user to communicate with the computer 602, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 606 and/or storage medium 610 may be used to store data such as cached data, files for user accounts, user profiles, account balances, transaction histories, files downloaded or received from other devices, and any other data items. Further still, the storage medium 610 may store the reporting application 112, the trading data 116, trade status 118, trade reports 120, hub application 122, reporting repository 124, client application 114, global trading application 126, and/or trade repository 128.

The interconnect 608 is representative of any type of circuitry to connect the components of the computer 602. For example, the interconnect 608 can include or represent, a system bus, a USB interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 604 to the memory 606, individual electrical connections among the components, and electrical conductive traces on a motherboard common to some or all of the above-described components of the computer 602. As discussed herein, the interconnect 608 may operatively couple various components with one another, or in other words, electrically connects those components, either directly or indirectly—by way of intermediate component(s)—with one another.

The one or more input devices 616 are representative of any type of input device for receiving input, such as a keypad, keyboard, touchscreen, touchpad, microphone, camera, fingerprint sensor, mouse, joystick, other pointer device, button, soft key, and the like. The one or more output devices 618 are representative of any type of device for outputting information, such as a monitor, speaker, haptic feedback module, printer, and the like.

The computer 602 may use the communications interface 612 to communicate with one or more other devices 624 via a network 622. The communications interface 612 allows the computer 602 to communicate with and conduct transactions with other devices and systems, such as the other devices 624. The communications interface 612 may be a wired and/or a wireless interface. Communications may be conducted via various modes or protocols, of which Global System for Mobile Communications (GSM) voice calls, Short Message Service (SMS), Enhanced Messaging Service (EMS), Multimedia Messaging Service (MMS) messaging, Time Division Multiple Access (TDMA), Code Division Multiple Access (CDMA), Personal Digital Cellular (PDC), Wideband Code Division Multiple Access (WCDMA), CDMA2000, and General Packet Radio Service (GPRS), are all non-limiting and non-exclusive examples. Thus, communications can be conducted, for example, via the wireless communications interface 612, which can be or include a radio-frequency transceiver, a Bluetooth device, Wi-Fi device, a Near-Field Communication (NFC) device, and other wireless transceivers. In addition, a positioning device 614 such as a Global Positioning System (GPS) device may be included for navigation and location-related data exchanges, ingoing and/or outgoing. Wi-Fi networks use radio technologies such as the Institute of Electrical and Electronics Engineers (IEEE) 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). A Wi-Fi network connects computers to each other, to the Internet, and to wired networks (which use IEEE 802.3-related media and functions). Communications may also and/or alternatively be conducted via wired connections using the communications interface 612, e.g., using USB, Ethernet, and other physically connected modes of data transfer. The network 622 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 602 is configured to use the communications interface 612 as, for example, a network interface to communicate with one or more other devices on a network such as network 622. In this regard, the computer 602 utilizes the wireless communications interface 612 as an antenna operatively coupled to a transmitter and a receiver (together a “transceiver”) included with the communications interface 612. The communications interface 612 is configured to provide signals to and receive signals from the transmitter and receiver, respectively. The signals may include signaling information in accordance with the air interface standard of the applicable cellular system of a wireless telephone network. In this regard, the computer 602 may be configured to operate with one or more air interface standards, communication protocols, modulation types, and access types. By way of illustration, the computer 602 may be configured to operate in accordance with any of a number of first, second, third, fourth, fifth-generation communication protocols and/or the like. For example, the as a smartphone, the computer 602 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 602 may also be configured to operate in accordance with non-cellular communication mechanisms, such as via a wireless local area network (WLAN) or other communication/data networks.

The communications interface 612 may also include a payment network interface. The payment network interface may include software, such as encryption software, and hardware, such as a modem, for communicating information to and/or from one or more devices on a network. For example, the computer 602 may be configured so that it can be used as a credit or debit card by, for example, wirelessly communicating account numbers or other authentication information to a terminal of the network. Such communication could be performed via transmission over a wireless communication protocol such as the NFC protocol.

The computer 602 may be under the control of any suitable operating system (not pictured). Example operating systems include, but are not limited to, Linux® operating systems, UNIX®, Windows® operating systems, macOS®, iOS®, Android® and any other type of operating system.

The computer 602 as illustrated diagrammatically represents at least one example of a possible implementation, where alternatives, additions, and modifications are possible for performing some or all of the described methods, operations, and functions. Although shown separately, in some embodiments, two or more computers 602, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described to explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
transmitting, by a processor, a plurality of messages to a reporting hub, each message associated with a respective event of a plurality of events;
determining, by the processor for each message, whether an acknowledgement of the respective message is received or not received from a global repository;
generating, by the processor, a report comprising a first subset of the plurality of events, the first subset comprising events for which the acknowledgment of the corresponding message is not received;
generating, by the processor based on a predetermined reporting period, an unresolved event notification for a first event of the first subset of the plurality of events; and
transmitting, by the processor to a reporting system, the unresolved event notification within the predetermined reporting period.

2. The method of claim 1, further comprising:
determining, by the processor for each message, whether a non-acknowledgment of the respective message is received from the global repository.

3. The method of claim 2, further comprising:
determining, by the processor, a second subset of the plurality of events, the second subset comprising events for which the non-acknowledgment of the corresponding message is received; and
adding, by the processor, the second subset of the plurality of events to the report.

4. The method of claim 3, further comprising:
determining, by the processor, a cause of the non-acknowledgment for a second event of the second subset of the plurality of events;
generating, by the processor, a corrected message for the second event; and
transmitting, by the processor, the corrected message to the reporting hub.

5. The method of claim 4, wherein the cause of the non-acknowledgment is based on omission of a first data field of a plurality of data fields required for the plurality of messages.

6. The method of claim 5, further comprising:
determining, by the processor, a value for the first data field for the second event; and
generating, by the processor, the corrected message including the value for the first data field.

7. The method of claim 4, further comprising:
receiving, by the processor, an acknowledgment for the second event based on the corrected message.

8. The method of claim 7, further comprising:
removing, by the processor, the second event from the report.

9. The method of claim 1, further comprising:
determining, by the processor for each message, whether a failure of the respective message is received from the reporting hub.

10. The method of claim 9, further comprising:
determining, by the processor, a second subset of the plurality of events, the second subset comprising events for which the failure of the corresponding message is received from the reporting hub; and
adding, by the processor, the second subset of the plurality of events to the report.

11. The method of claim 1, further comprising:
determining, by the processor for each message, whether a response is received from the reporting hub or the global repository;
determining, by the processor, a second subset of the plurality of events, the second subset comprising events for which no response is received from the reporting hub or the global repository; and
adding, by the processor, the second subset of the plurality of events to the report.

12. The method of claim 1, wherein the report includes a second event of the first subset of the plurality of events.

13. The method of claim 12, further comprising:
receiving, by the processor from the global repository, the acknowledgement for the second event; and
removing, by the processor based on receiving the acknowledgement for the second event, the second event from the report.

14. The method of claim 1, wherein the acknowledgement is received for a second message of the plurality of messages, the second message associated with a second event of the plurality of events, wherein the report does not include the second event.

15. The method of claim 14, further comprising:
receiving, by the processor for the second event, a non-acknowledgment from the global repository; and
adding, by the processor based on receiving the non-acknowledgment from the global repository, the second event to the report.

16. The method of claim 1, further comprising, prior to generating the unresolved event notification:
transmitting, by the processor, the report to a plurality of recipients.

17. The method of claim 1, wherein the plurality of messages are included in a file.

18. The method of claim 1, further comprising:
generating, by the processor, a graphical user interface comprising indications of the first subset of the plurality of events.

19. A non-transitory computer-readable storage medium, the computer-readable storage medium including instructions that when executed by a processor, cause the processor to:
transmit a plurality of messages to a reporting hub, each message associated with a respective event of a plurality of events;
determine, for each message, whether an acknowledgement of the respective message is received or not received from a global repository;
generate a report comprising a first subset of the plurality of events, the first subset comprising events for which the acknowledgment of the corresponding message is not received;
generate, based on a predetermined reporting period, an unresolved event notification for a first event of the first subset of the plurality of events; and
transmit, to a reporting system, the unresolved event notification within the predetermined reporting period.

20. An apparatus, comprising:
a processor; and
a memory storing instructions that, when executed by the processor, cause the processor to:
transmit a plurality of messages to a reporting hub, each message associated with a respective event of a plurality of events;
determine, for each message, whether an acknowledgement of the respective message is received or not received from a global repository;
generate a report comprising a first subset of the plurality of events, the first subset comprising events for which the acknowledgment of the corresponding message is not received;
generate, based on a predetermined reporting period, an unresolved event notification for a first event of the first subset of the plurality of events; and
transmit, to a reporting system, the unresolved event notification within the predetermined reporting period.
